(19) United States
(12) Patent Application Publication
(10) Pub. No.: US 2025/0052694 A1
(43) Pub. Date: Feb. 13, 2025

(54) MICROWAVE MEASURING DEVICE

(71) Applicant: Endress+Hauser Flowtec AG, Reinach (CH)

(72) Inventors: Anne Habermehl, Erding (DE); Wolfgang Drahm, Freising (DE); Raphael Kuhnen, Schliengen (DE); Christof Huber, Bern (CH)

(21) Appl. No.: 18/721,344

(22) PCT Filed: Nov. 22, 2022
(86) PCT No.: PCT/EP2022/082778

§ 371 Date: Jun. 18, 2024

(30) Foreign Application Priority Data
Dec. 22, 2021 (DE) 10 2021 134 246.5

(51) Int. Cl. G01N 22/00; G01N 24/08; G01N 27/04

(52) U.S. Cl. CPC G01N 22/00; G01N 24/08; G01N 27/041

(57) ABSTRACT

A microwave measuring device comprises a measuring tube for conducting the medium; a first microwave antenna designed to generate a variable microwave signal and to emit said signal into the medium; and a magnetic-field-sensitive measuring device for determining a magnetic field and comprising a measuring device component having an optically excitable material, the microwave signal acting on the optically excitable material; an optical excitation device designed to optically excite the optically excitable material; and an optical detection device designed to provide a detection signal correlating with a light emitted by the optically excitable material. An evaluation circuit is designed to determine a magnetic field and/or a change in the magnetic field on the basis of the detection signal.

The invention relates to a microwave measuring device for determining a proportion of solids in a medium and at least one further physical and/or chemical variable of the medium.

It is possible, by means of microwaves, to determine the physical quantities of permittivity and loss factor of a medium in a process line. From these two variables—measured either at one or over many different frequencies—it is possible to draw conclusions regarding application-specific parameters, for example the proportion of water in a mixture of water and other non-polar or weakly polar components.

The established transmission/reflection measurement is described in L. F. Chen, C. K. Ong, C. P. Neo, V. V. Varadan, V. K. Varadan—“Microwave Electronics, Measurement and Materials Characterization,” John Wiley & Sons Ltd., 2004. For this purpose, the microwave signal interfaces at two different positions at the medium in a container or measuring tube, the scatter parameters (transmission and optionally reflection) are measured between these interface structures, and the mentioned physical properties of the medium are calculated from the measured scatter parameters.

WO 2018 121927 A1 teaches a measuring assembly for analyzing properties of a flowing medium by means of microwaves. In addition to the microwave antennas, the measuring assembly has an electrically insulating lining layer on the inner peripheral surface of the measuring tube. This lining layer forms a dielectric waveguide via which at least part of the one microwave signal can travel from a first microwave antenna to a second microwave antenna. One application for such a measuring assembly is the determination of the proportions of solids in the medium being conveyed.

A newer development in the field of sensor technology is represented by so-called quantum sensors, in which a wide variety of quantum effects are utilized for determining various physical and/or chemical measured variables. In the field of industrial process automation, such approaches are of interest in particular with regard to increasing efforts towards miniaturization, while at the same time increasing the performance of the respective sensors.

Quantum sensors are based upon the fact that certain quantum states of individual atoms can be controlled and read very precisely. In this way, for example, precise and low-interference measurements of electrical and/or magnetic fields as well as gravitational fields with resolutions in the nanometer range are possible. In this context, various spin-based sensor assemblies have become known, for which atomic transitions in crystal bodies are used for detecting changes of movements, electrical and/or magnetic fields or also gravitational fields. Furthermore, different systems based on quantum-optic effects have also become known, such as quantum-gravimeters, NMR gyroscopes or optically pumped magnetometers, wherein in particular the latter are based, inter alia, on gas cells.

For example, in the field of spin-based quantum sensors, various devices have become known that utilize atomic transitions, for example in various crystal bodies, in order to detect even small changes in movements, electric and/or magnetic fields or even gravitational fields. Typically, diamond having at least one nitrogen vacancy center, silicon carbide having at least one silicon vacancy, or hexagonal boron nitride having at least one vacancy color center is used as crystal body. The crystal bodies can in principle have one or more vacancies.

DE 10 2017 205 099 A1 discloses a sensor device having a crystal body having at least one vacancy, a light source, a high-frequency device for applying a high-frequency signal to the crystal body, and a detection unit for detecting a magnetic-field-dependent fluorescence signal. The light source is arranged on a first substrate, and the detection device is arranged on a second substrate, while the high-frequency device and the crystal body can be arranged on the two interconnected substrates. External magnetic fields, electrical currents, temperature, mechanical stress or pressure can be used as measured variables. A similar device has become known from DE 10 2017 205 265 A1.

DE 10 2014 219 550 A1 describes a combination sensor for detecting pressure, temperature and/or magnetic fields, wherein the sensor element has a diamond structure with at least one nitrogen vacancy center.

DE 10 2018 214 617 A1 discloses a sensor device which also has a crystal body with a number of color centers, in which device various optical filter elements are used to increase effectiveness and for miniaturization.

From the heretofore unpublished German patent application with the file number 10 2020 123 993.9, a sensor device has become known which uses a fluorescence signal of a crystal body having at least one vacancy to evaluate a process variable of a medium. In addition, a state monitoring of the respective process is carried out on the basis of a variable that is characteristic for the magnetic field, such as the magnetic permeability or magnetic susceptibility. From the German patent application with the file number 10 2021 100223.0, which also has not yet been published, a point level sensor has also become known in which a statement about a point level is determined on the basis of the fluorescence.

Another sub-area in the field of quantum sensors relates to gas cells in which atomic transitions and spin states can be optically queried, among other things, to determine magnetic and/or electrical properties. In general, a gaseous alkali metal and a buffer gas are present in the gas cell. Magnetic properties of a surrounding medium can be determined by Rydberg states generated in the gas cell.

For example, gas cells are used in quantum-based standards which provide physical variables with high precision. They have therefore long been used in frequency standards or atomic clocks, as is known from EP 0 550 240 B1.

U.S. Pat. No. 10,184,796 B2 further discloses an atomic gyroscope in chip size in which a gas cell is used to determine the magnetic field. An optically pumped magnetometer based on a gas cell is known from U.S. Pat. No. 9,329,152 B2. By manipulating the atomic states in gas cells, further fields of application of gas cells can be deduced. For example, JP 4066804 A2 describes the use of gas cells for determining absolute path lengths. Furthermore, gas cells are also used as a starting point for microwave sources, as described in EP 1 224 709 B1.

Many measuring principles known from the prior art allow a characterization of the respective medium with regard to its magnetic and/or electrical properties. In this context, both invasive measuring devices, in which the respective sensor unit is brought into direct contact with the respective medium, and non-invasive measuring devices, in which the process variable is acquired outside the container, are used. Non-invasive measuring devices generally offer the advantage that no intervention in the process is necessary. However, such measuring devices are currently only available to a limited extent, because many different factors must be taken into account with regard to the achievable measuring accuracy and possible interferences, for example due to the container wall or the environment, particularly with regard to measuring accuracy.

A further aim is to achieve continuous miniaturization while at the same time increasing the performance of the respective sensors. Sensors that allow comprehensive characterization of the respective medium with regard to many different physical and/or chemical properties are therefore desirable. With regard to magnetic and/or electrical properties, precise devices for detecting changes in magnetic fields, detecting magnetic fields and, depending on the sensor type, detecting gravitational fields are required in this context.

The object of the invention is to further develop the measuring principle of microwave technology.

The object is achieved by the microwave measuring device according to claim 1.

The microwave measuring device according to the invention, in particular for determining a proportion of solids of a flowable medium, comprising:
a measuring tube for conducting the medium;
a first microwave antenna which is designed to generate a particularly variable microwave signal, and emit said signal into the medium; and
at least a first magnetic-field-sensitive measuring device for determining a magnetic field, comprising:
   a measuring device component having an optically excitable material,
      the microwave signal acting on the optically excitable material;
   an optical excitation device which is designed to optically excite the optically excitable material; and
   an optical detection device which is designed to provide a detection signal correlating with light emitted by the optically excitable material;
an evaluation circuit which is designed to determine a magnetic field and/or a change in the magnetic field on the basis of the detection signal.

Microwave measuring devices for determining a proportion of solids are used, for example, in applications for controlling sludge removal in primary or secondary clarification, for optimizing the consumption of flocculants during the thickening of digested sludge and/or for optimizing the dewatering of excess sludge. For this purpose, at least a first microwave antenna is provided to emit a microwave signal into the medium to be conducted and monitored. The emitted microwave signal penetrates the medium and is reflected on the inner wall of the measuring tube back to the first microwave antenna, where it is detected. In this case, the first microwave antenna is also designed to measure the reflected microwave signal. The reflected and detected microwave signal can be used to determine the proportion of solids in the medium. Alternatively, a further microwave antenna can be provided to detect the microwave signal of the first microwave antenna.

The first magnetic-field-sensitive measuring device is designed to determine a physical and/or chemical property of the medium. Depending on the determined physical and/or chemical properties of the medium, a corrected proportion of solids can be determined. The microwave signal can be used for preferential polarization of the nuclear spins of the medium as well as to excite the optically excitable material. To excite the optically excitable material, the optical excitation device is designed to generate an optical excitation signal, in particular at a fixed frequency. The optical detection device is adapted to detect the fluorescence signal emitted by the optically excitable material and to provide a detection signal comprising the intensity of the fluorescence signal.

Advantageous embodiment of the invention are the subject matter of the dependent claims.

One embodiment provides that the microwave signal comprises a sequence of high-frequency signals.

On the one hand, this allows the use of highly complex models—thanks to the broad spectrum of frequencies and associated measurement signal intensity—for the determination of the proportion of solids and, at the same time, the determination of a frequency-dependent absorption spectrum on the optical detection device.

One embodiment further comprises:
a second microwave antenna, which is arranged diametrically to the first microwave antenna,
   wherein the second microwave antenna is designed to receive the microwave signal.

The second microwave antenna is designed to detect or measure the emitted microwave signal. On the way from the first microwave antenna to the second microwave antenna, the microwave signal propagates through the medium and through any solid matter in the medium. The evaluation circuit is designed to determine the proportion of solids in the medium on the basis of the microwave signal received. The concentration of the dry substance in the medium is determined on the basis of the signal propagation time of microwaves.

One embodiment further comprises:
at least a second magnetic-field-sensitive measuring device,
   wherein the first magnetic-field-sensitive measuring devices and the second magnetic-field-sensitive measuring device are arranged spaced apart around the circumference of the measuring tube.

The advantage of the embodiment is that the two magnetic-field-sensitive measuring devices can monitor the physical and/or chemical properties of the medium at two different positions in the measuring tube. In this way, a first region—in which, for example, a coating typically forms first or the solids move along—can be monitored independently of a second region—which is free of solids.

One embodiment further comprises:
a magnetic-field-generating device for generating a magnetic field in the medium;
an operating circuit which is designed to feed an electrical operating signal into the magnetic-field-generating device,
   wherein the operating signal is designed such that the magnetic field generated by the magnetic-field-generating device excites moving charge carriers in the medium to move.

The magnetic-field-generating device is preferably designed to induce a preferential polarization of the nuclear spins in the medium and to generate a magnetic field, in particular a static magnetic field, at least in one region of the respective magnetic-field-sensitive measuring device, in particular in the region of the optically excitable material.

One embodiment provides that at least a part of the second magnetic-field-sensitive measuring device, in particular the measuring device component, is integrated in the second microwave antenna.

Thus, for example, the part of the second microwave antenna in contact with the medium can be monitored by means of the second magnetic-field-sensitive measuring device. Integrating the second magnetic-field-sensitive measuring device in the second microwave antenna also has the advantage that the intensity of the microwave signal is maximized and that there is no need for an additional opening in the measuring tube.

Alternatively, it is possible to integrate only the first magnetic-field-sensitive measuring device in the first microwave antenna.

In one embodiment, the evaluation circuit is designed to determine the electrical conductivity of the medium on the basis of the detection signal,
wherein the detection signal correlates with a change and/or a strength of a magnetic field generated by the moving charge carriers of the medium.

The embodiment makes use of the fact that the moving charge carriers of the medium generate a magnetic field through their movement due to a changing but known magnetic field. The conductivity of the medium can be determined by measuring the generated magnetic field using the magnetic-field-sensitive measuring device. The determined conductivity can be included in the determination of the corrected proportion of solids.

One embodiment provides that the evaluation circuit is designed to detect foreign bodies in the medium on the basis of the detection signal, in particular on the basis of a deviation of the detection signal from a criterion, in particular a variable criterion.

The embodiment makes use of the fact that even the smallest magnetic fields can be detected using the magnetic-field-sensitive measuring devices. This means that even the smallest magnetic or metallic particles in the medium can be detected. Furthermore, a magnetic-field-generating device can be used to detect foreign objects that are neither metallic nor magnetic. Plastic or ceramic foreign bodies in the medium disturb the magnetic field generated by the movement of the moving charge carriers in the medium. According to the invention, this disturbance is determined using the magnetic-field-sensitive measuring device or devices and, on the basis of defined criteria, a statement can be made about the presence of a foreign object.

One embodiment provides that the evaluation circuit is designed to determine a chemical or physical property of the medium on the basis of the detection signal influenced by a nuclear spin resonance of the medium.

Many atomic nuclei have a nuclear spin different from zero and therefore a magnetic moment as rotating charge carriers, such as e.g., 1 H atoms or 13 C atoms. In a static magnetic field, nuclear spins result in a precessing movement, the so-called Larmor precession, about the axis of the constant magnetic field. In this case, the atomic nuclei change the orientation of their nuclear spins relative to the magnetic field by absorption or emission of alternating magnetic fields if they are resonant with the Larmor frequency. This is also known as nuclear spin resonance. The possible magnetic rotary pulse quantum states of the nuclear spins are equidistant and dependent on the Larmor frequency. The frequency and the duration of the Larmor precession are dependent on the respective nuclear spin along with its spatial and chemical environment. The detection of the Larmor precessions on the basis of the Larmor frequencies therefore enables a very precise determination of the chemical composition of the sample and the spatial structure of the molecules contained in the sample. According to the embodiment, the high sensitivity of the first magnetic-field-sensitive measuring device to the magnetic fields in the medium is utilized in order to determine the chemical or physical property of the medium.

In one embodiment, the measuring tube is divided into two sections by a measuring tube plane,
wherein the first microwave antenna and at least the first magnetic-field-sensitive measuring device are arranged in different sections.

One embodiment provides that the optically excitable material has at least one crystal body with at least one vacancy or at least one gas cell.

One embodiment provides that the crystal body is a diamond having at least one nitrogen vacancy, silicon carbide having at least one silicon vacancy, or hexagonal boron nitride having at least one vacancy color center.

One embodiment provides that the gas cell is a cell which includes at least one gaseous alkali metal.

The microwave measuring device comprises an excitation device for optically exciting the optically excitable material or the crystal body or the gas cell, and a detection unit for detecting a fluorescence signal of the crystal body or the gas cell correlating with the magnetic field acting upon the magnetic-field-sensitive measuring device, in particular the optically excitable material. Optionally, filters and mirrors as well as further optical elements can be used to direct an excitation light to the crystal body or to the gas cell and/or the fluorescence signal towards the detection unit. The crystal body is exposed to the frequency-dependent microwave signal, which is generated by a magnetic-field-sensitive measuring device. The advantage of the embodiment is that such measuring systems can be realized very compactly and can be easily integrated into the microwave measuring device. Furthermore, it is advantageous that even very small magnetic fields or changes in the magnetic field can be detected with the magnetic-field-sensitive measuring devices according to the invention, in particular crystal bodies.

The invention is explained in greater detail with reference to the following figures. In the figures:

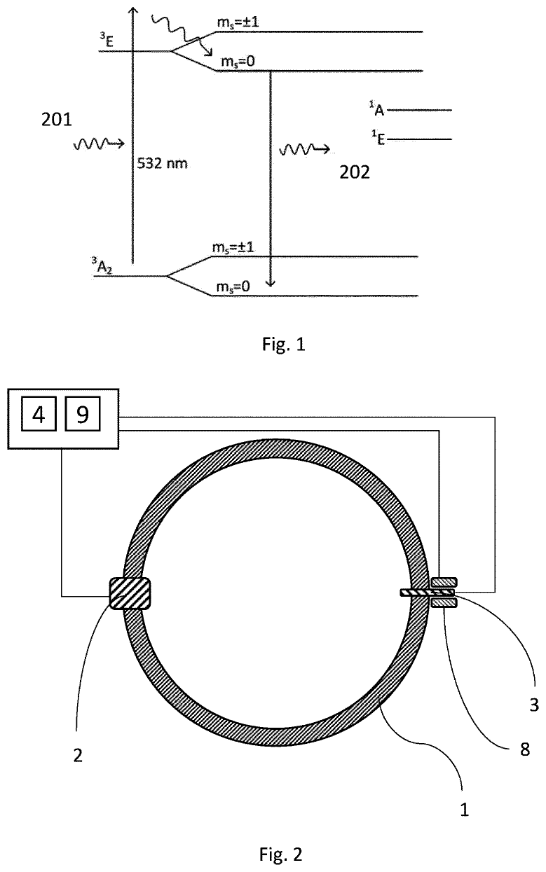

FIG. 1: shows a simplified energy diagram for a negatively charged NV center in the diamond;

FIG. 2: shows a cross section through a first embodiment of the microwave measuring device;

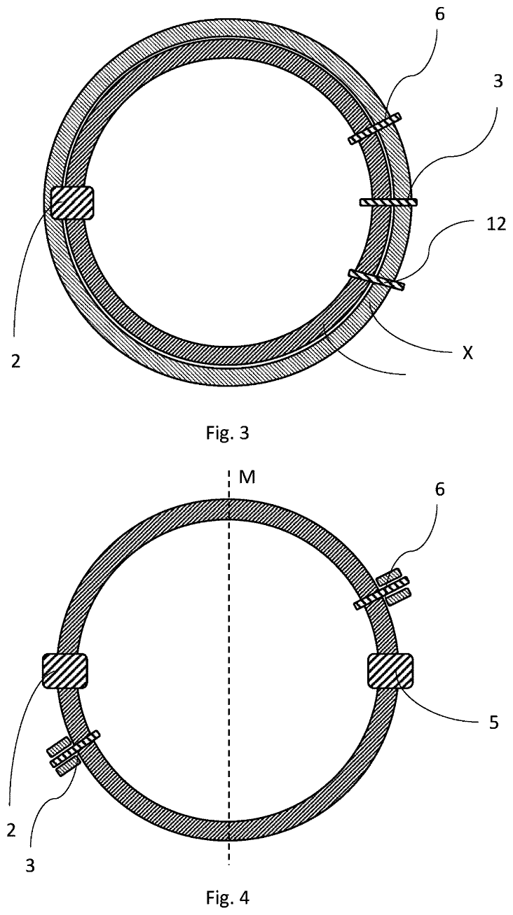

FIG. 3: shows a cross section through a second embodiment of the microwave measuring device;

FIG. 4: shows a cross section through a third embodiment of the microwave measuring device;

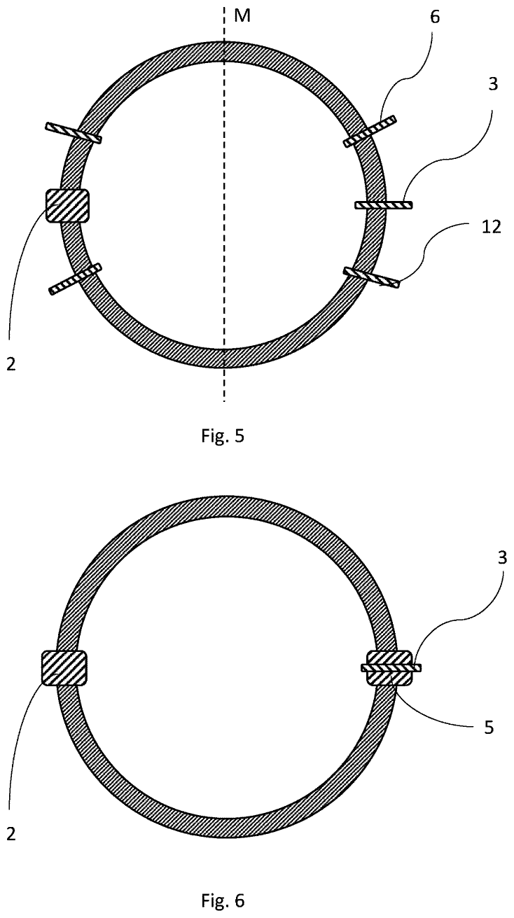

FIG. 5: shows a cross section through a fourth embodiment of the microwave measuring device;

FIG. 6: shows a cross section through a fifth embodiment of the microwave measuring device; and

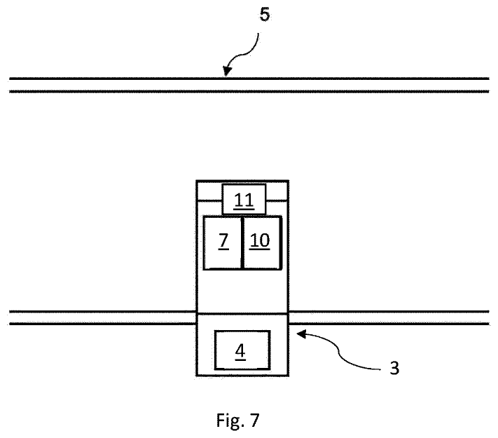

FIG. 7: shows a longitudinal section through the first embodiment of the microwave measuring device.

FIG. 1 shows a simplified energy diagram for a negatively charged NV center in a diamond to give an exemplary explanation of the excitation and fluorescence of a vacancy in a crystal body. The following considerations can be transferred to other crystal bodies having corresponding vacancies.

In the diamond, each carbon atom is typically covalently bonded to four further carbon atoms. A nitrogen vacancy center (NV center) consists of a vacancy in the diamond lattice, i.e., an unoccupied lattice site, and a nitrogen atom as one of the four neighboring atoms. In particular, the negatively charged NV centers are important for the excitation and evaluation of fluorescence signals. In the energy diagram of a negatively charged NV center, there is a triplet ground state ³A and an excited triplet state ³E, each of which has three magnetic substrates mₛ=0, ±1. Furthermore, there are two metastable singlet states ¹A and ¹E between the ground state ³A and the excited state ³E.

Excitation light 201 from the green range of the visible spectrum, e.g., an excitation light 201 with a wavelength of 532 nm, excites an electron from the ground state ³A into a vibrational state of the excited state 3E, which returns to the ground state ³A by emitting a fluorescence photon 202 with a wavelength of 630 nm. An applied magnetic field with a magnetic field strength B leads to a splitting (Zeeman splitting) of the magnetic sub-states, so that the ground state consists of three energetically separated sub-states, each of which can be excited. However, the intensity of the fluorescence signal is dependent on the respective magnetic substrate from which it was excited, so that the magnetic field strength B, for example, can be calculated using the Zeeman formula on the basis of the distance between the fluorescence minima. In the context of the present invention, further possibilities for evaluating the fluorescence signal are provided, such as the evaluation of the intensity of the fluorescent light, which is likewise proportional to the applied magnetic field. An electrical evaluation can in turn be done, for example, via a Photocurrent Detection of Magnetic Resonance (PDMR). In addition to these examples for evaluating the fluorescence signal, there are other possibilities which also fall within the scope of the present invention.

The excitation of gas cells is not explicitly shown, but in gas cells as well, the excitation with light of a defined wavelength causes an excitation of an electron, wherein an emission of a fluorescent light subsequently follows. For example, the intensity and/or the wavelength of the emitted fluorescent light is used to determine the magnetic field.

FIG. 2 shows a cross section through a first embodiment of the microwave measuring device for determining a proportion of solids of a flowable medium. The microwave measuring device comprises a measuring tube 1 for conducting the medium, a first microwave antenna 2, which is designed to generate a particularly variable microwave signal and to emit said signal into the medium, and a first magnetic-field-sensitive measuring device 3 for determining a magnetic field which is arranged diametrically to the first microwave antenna 2. The first microwave antenna 2 is positioned in contact with the medium in an opening in the measuring tube 1. The first microwave antenna 2 can be a waveguide antenna or a planar antenna, for example. The measuring tube 1 comprises a carrier tube, in particular a metal one. An evaluation circuit 4 is designed to determine a magnetic field and/or a change in the magnetic field on the basis of a detection signal. The evaluation circuit 4 comprises a microprocessor for processing the detection signal provided on the optical detection device 10 and generally comprises a large number of individual electrical or electromechanical elements (battery, switch, display, . . . ) to form a functional arrangement. Furthermore, the evaluation circuit 4 is designed to process a microwave signal measured at the first microwave antenna 2. Furthermore, the evaluation circuit is designed to determine a magnetic field and/or a change in the magnetic field on the basis of the detection signal.

FIG. 7 shows a longitudinal section through the first embodiment of the microwave measuring device with a more detailed representation of the first magnetic-field-sensitive measuring device 3. The first magnetic-field-sensitive measuring device 3 comprises a measuring device component with an optically excitable material 11, which interacts with the microwave signal comprising a sequence of high-frequency signals. In addition, the first magnetic-field-sensitive measuring device 3 comprises an optical excitation device 7, which is designed to optically excite the optically excitable material 11, and an optical detection device 10 which is designed to provide a detection signal that correlates with a fluorescence signal, in particular light, emitted by the optically excitable material 11. The optically excitable material 11 comprises at least one crystal body having at least one vacancy, wherein the crystal body is a diamond having at least one nitrogen vacancy, silicon carbide having at least one silicon vacancy, or hexagonal boron nitride having at least one vacancy color center. The optically excitable material 11 can also be formed as a coating with a large number of crystal bodies.

Alternatively, the optically excitable material 11 can have a gas cell which is designed as a cell enclosing at least one gaseous alkali metal.

FIG. 2 also shows a magnetic-field-generating device 8 for generating a magnetic field in the medium. The magnetic-field-generating device 8 can comprise a coil or a permanent magnet. In the event that the magnetic-field-generating device 8 comprises a coil, an operating circuit 9 is also provided which is designed to feed an electrical operating signal into the magnetic-field-generating device 8, in particular into the coil. A magnetic-field-generating device 8 is provided for the induction of preferential polarization of the nuclear spins of the medium. The magnetic-field-generating device 8 generates a homogeneous magnetic field at least in the region of the first magnetic-field-sensitive measuring device and in the region of the optically excitable material.

The operating signal can be designed in such a way that the magnetic field generated by the magnetic-field-generating device 8 excites moving charge carriers in the medium to move. Based on the movement of the moving charge carriers, for example, a conductivity of the medium can be determined via the evaluation circuit 4 on the basis of the detection signal, because this correlates with a change and/or a strength of a magnetic field generated by the moving charge carriers of the medium.

Alternatively, the evaluation circuit 4 can be designed to detect foreign bodies in the medium on the basis of the detection signal, in particular on the basis of a deviation of the detection signal from a criterion, in particular a variable criterion.

According to a further alternative, the evaluation circuit 4 can be designed to determine a chemical and/or physical property of the medium on the basis of the detection signal influenced by a nuclear spin resonance of the medium. This allows the composition of the medium and/or the slightest impurities in the medium to be detected.

FIG. 3 shows a cross section through a second embodiment of the microwave measuring device. The second embodiment differs from the first embodiment in that more than just one magnetic-field-sensitive measuring device is provided. In addition to the first magnetic-field-sensitive measuring device 3, a second magnetic-field-sensitive measuring device 6 and a third magnetic-field-sensitive measuring device 12 are each arranged in contact with the medium in an opening provided in the measuring tube. The first magnetic-field-sensitive measuring device 3, the second magnetic-field-sensitive measuring device 6 and the third magnetic-field-sensitive measuring device 12 are arranged spaced apart around the circumference of the measuring tube. The measuring tube comprises a metallic carrier tube 13 with an electrically insulating liner 14 arranged on the inside. The microwave signal emitted by the first microwave antenna 2 propagates through the medium to the opposite magnetic-field-sensitive measuring device 3, 6, 12 in order to induce a preferential polarization in the electron spins of the sensor component and then transfer this preferential polarization of the electron spins to the nuclear spins of the sample. If the microwave signal covers a frequency range of preferably 0.3 to 20 GHz, in particular from 1.8 to 8.5 GHZ and preferably from 1.8 to 3.0 GHZ, then a frequency-dependent absorption spectrum can be generated for an optical excitation signal with a fixed frequency, which is provided in the form of the detection signal on the optical detection device. With the help of minima in the intensity of the detection signal, in particular the position of the minima, the smallest magnetic fields or changes in the magnetic field can be detected.

More than three magnetic-field-sensitive measuring devices 3, 6, 12 can also be provided. In addition, the magnetic-field-sensitive measuring devices 3, 6, 12 can also be arranged in the immediate vicinity of the first microwave antenna 2. See the fourth embodiment in FIG. 5.

FIG. 4 shows a cross section through a third embodiment of the microwave measuring device. The third embodiment differs from the first embodiment in that, in addition to the first microwave antenna 2, a second microwave antenna 5 is inserted in an opening in the measuring tube. The second microwave antenna 5 is arranged diametrically to the first microwave antenna 2 and is designed to receive the microwave signal emitted by the first microwave antenna 2. The evaluation circuit (not shown) is designed to determine a proportion of solids of the medium depending on the microwave signal received on the second microwave antenna 5. In addition, the microwave signal generated and emitted can be included in the determination of the proportion of solids. Both microwave antennas 2, 5 can each be designed to transmit and/or receive a microwave signal. Furthermore, in addition to the first magnetic-field-sensitive measuring device 3, the third embodiment comprises a further second magnetic-field-sensitive measuring device 6. This is arranged diametrically to the first magnetic-field-sensitive measuring device 3. Both magnetic-field-sensitive measuring devices 3, 6 interact with the microwave signals of the microwave antennas 2, 5, because said signals propagate from the respective microwave antenna 2, 5 in all directions within the measuring tube. A measuring tube plane M intersects the measuring tube and divides it, at least in sections, into two sections of substantially equal volume. Each of the two sections comprises a microwave antenna and a magnetic-field-sensitive measuring device. The two magnetic-field-sensitive measuring devices each have a magnetic-field-generating device that is designed to generate a magnetic field locally. This can be constant or variable. The magnetic-field-sensitive measuring devices are each electrically connected to the evaluation circuit (not shown). This is designed to determine an approximate position of a foreign object and/or a degree of contamination depending on the detection signals determined and provided by the magnetic-field-sensitive measuring devices.

FIG. 6 shows a cross section through a fifth embodiment of the microwave measuring device. The fifth embodiment differs from the first embodiment in that, in addition to the first microwave antenna 2, a second microwave antenna 5 arranged diametrically to it is provided. This is designed to detect the microwave signal emitted by the first microwave antenna 2 and, if necessary, to emit its own microwave signal. The first magnetic-field-sensitive measuring device 3, in particular its measuring device component or the optically excitable material 11, is integrated in at least a part of the second microwave antenna 5. This can be implemented, for example, in such a way that an opening is provided in the second microwave antenna 5 into which the first magnetic-field-sensitive measuring device 3 is inserted. Alternatively, the second microwave antenna 5 can also be provided with a blind hole at least in sections.

### LIST OF REFERENCE SIGNS

Measuring tube 1
First microwave antenna 2
First magnetic-field-sensitive measuring device 3
Evaluation circuit 4
Second microwave antenna 5
Second magnetic-field-sensitive measuring device 6
Optical detection device 7
Magnetic-field-generating device 8
Operating circuit 9
Optical detection device 10
Optically excitable material 11
Third magnetic-field-sensitive measuring device 12
Carrier tube 13
Liner 14

1-14. (canceled)

15. A microwave measuring device for a flowable medium, comprising:
a measuring tube for conducting the medium;
a first microwave antenna designed to generate a variable microwave signal and emit said signal into the medium;
a first magnetic-field-sensitive measuring device for determining a magnetic field, the first magnetic-field-sensitive measuring device including:
a measuring device component having an optically excitable material, wherein the microwave signal acts on the optically excitable material;
an optical excitation device designed to optically excite the optically excitable material; and
an optical detection device designed to provide a detection signal correlating with light emitted by the optically excitable material; and
an evaluation circuit designed to determine a magnetic field and/or a change in the magnetic field on the basis of the detection signal.

16. The microwave measuring device according to claim 15,
wherein the microwave signal comprises a sequence of high-frequency signals.

17. The microwave measuring device according to claim 15, further comprising:
a second microwave antenna arranged diametrically to the first microwave antenna,
wherein the second microwave antenna is arranged to receive the microwave signal.

18. The microwave measuring device according to claim 17,
wherein the evaluation circuit is designed to determine a proportion of solids in the medium on the basis of the received microwave signal.

19. The microwave measuring device according to claim 17, further comprising:
a second magnetic-field-sensitive measuring device embodied in the same manner as the first magnetic-field-sensitive measuring device,
wherein the first magnetic-field-sensitive measuring devices and the second magnetic-field-sensitive measuring device are arranged spaced apart around a circumference of the measuring tube.

20. The microwave measuring device according to claim 17, further comprising:
a magnetic-field-generating device for generating a magnetic field in the medium; and
an operating circuit designed to feed an electrical operating signal into the magnetic-field-generating device,
wherein the operating signal is designed such that the magnetic field generated by the magnetic-field-generating device excites moving charge carriers in the medium to move.

21. The microwave measuring device according to 19,
wherein at least a part of the second magnetic-field-sensitive measuring device is integrated in the second microwave antenna.

22. The microwave measuring device according to claim 15,
wherein the evaluation circuit is designed to determine an electrical conductivity of the medium on the basis of the detection signal, and
wherein the detection signal correlates with a change and/or a strength of a magnetic field generated by the moving charge carriers of the medium.

23. The microwave measuring device according to claim 15,
wherein the evaluation circuit is designed to detect foreign bodies in the medium on the basis of a deviation of the detection signal from a criterion.

24. The microwave measuring device according to claim 15,
wherein the evaluation circuit is designed to determine a chemical and/or physical property of the medium on the basis of the detection signal influenced by a nuclear spin resonance of the medium.

25. The microwave measuring device according to claim 15,
wherein the measuring tube is divided into two sections in a measuring tube plane, and
wherein the first microwave antenna and the first magnetic-field-sensitive measuring device are arranged in different sections.

26. The microwave measuring device according to claim 15,
wherein the optically excitable material is a crystal body with at least one vacancy or is a gas cell.

27. The microwave measuring device according to claim 26,
wherein the crystal body is a diamond having at least one nitrogen vacancy, silicon carbide having at least one silicon vacancy, or hexagonal boron nitride having at least one vacancy color center.

28. The microwave measuring device according to claim 26,
wherein the gas cell is a cell which includes at least one gaseous alkali metal.
